(19) United States
(12) Patent Application Publication
(10) Pub. No.: US 2014/0257766 A1
(43) Pub. Date: Sep. 11, 2014

(54) ADAPTIVE PROBABILISTIC STEP DETECTION FOR PEDESTRIAN POSITIONING

(71) Applicant: QUALCOMM INCORPORATED, San Diego, CA (US)

(72) Inventors: Sameera Poduri, Sunnyvale, CA (US); Payam Pakzad, Mountain View, CA (US)

(73) Assignee: QUALCOMM INCORPORATED, San Diego, CA (US)

(21) Appl. No.: 13/787,531

(22) Filed: Mar. 6, 2013

(51) Int. Cl. G06N 7/00

(52) U.S. Cl. CPC G06N 7/005
USPC 703/2

(57) ABSTRACT

Performance of step detectors in mobile devices can be enhanced by calculating the probability of a step and providing the probability to an application. Adaptive data models can also be used that can be based on different types of motion (walking with mobile device in hand, climbing stairs with mobile device in purse, running with mobile device in pocket, etc.), and can adapt to a particular user's motion. Where applications allow, embodiments can further utilize data modeling to detect a pattern (e.g., a series of steps) and adjust the probability calculation accordingly.

### BACKGROUND

Pedometers and step detectors based on inertial sensors have found various applications in fitness, health monitoring, positioning systems, and more. Step detection in these applications is typically based on sensors that are constrained to a particular position with respect to a pedestrian (e.g., waist, wrist, shoes, etc.). For mobile phones and other mobile devices, step detection can be more difficult because the mobile device can be carried in any of a variety of locations (e.g., a pedestrian's hand, pocket, purse, etc.) and subject to combined motion due to steps, swinging of an arm while holding the mobile device, movement of a purse, and more. As such, step detection in mobile devices can be highly inaccurate.

### SUMMARY

Embodiments of the present invention are directed toward enhancing the performance of step detectors in mobile devices by calculating the probability of a step and providing the probability to an application. Embodiments can further improve the accuracy of step detection by utilizing adaptive data models that can be based on different types of motion (walking with mobile device in hand, climbing stairs with mobile device in purse, running with mobile device in pocket, etc.), and can adapt to a particular user's motion. Where applications allow, embodiments can further utilize data modeling to detect a pattern (e.g., a series of steps) and adjust the probability calculation accordingly.

An example method of step detection, according to the description, includes obtaining motion data indicative of a user's movement during a first time interval, determining one or more features of the motion data, and calculating, with a processing unit, a probability that a step was made. The probability can be based on at least one feature of the one or more features, and information indicative of the user's movement at a time prior to the first time interval.

The method of step detection also can include one or more of the following features. The method can include determining a motion state indicative of a type of the user's movement, where calculating the probability that a step was made is further based on the motion state. The motion state can be indicative of at least one of standing, sitting, running, fidgeting, walking, swinging or dangling a mobile device in hand, or the user's movement. The information indicative of the user's movement at a time prior to the first time interval can include a data model indicative of the user's movement at a second time interval previous to the first time interval. The method can further include updating the data model based on the motion data. The method can include using a data model to determine a pattern of the one or more features, wherein calculating the probability that a step was made is further based on the pattern. The data model can include a hidden Markov model. The one or more features can be indicative of at least one of a rate of change in acceleration, a magnitude of a change in acceleration, or a rate at which peaks in acceleration are detected.

Additionally or alternatively, the method of step detection can include one or more of the following features. The method can include accessing a probability that motion data over a previous interval corresponds to a step, where calculating the probability that a step was made over the first time interval is at least partially based on the probability that motion data over a second time interval, previous to the first time interval, corresponds to a step. Calculating a probability that a step was made can be performed on a mobile device. The method can include providing the probability that a step was made to an application executed by the mobile device. Obtaining the motion data can include receiving, at a server, the motion data. The method can include sending the probability that a step was made to mobile device; estimating a timestamp indicative of a point in time, during the first time interval, that corresponds to the probability that a step was made; and/or providing information indicative of at least one of a time stamp, a step event, a step probability history, a step rate, or a stride length.

An example mobile device, according to the disclosure, can include one or more motion sensors configured to measure motion data indicative of a user's movement of the mobile device during a first time interval, and a processing unit coupled to the one or more motion sensors. The processing unit is configured to perform functions including obtaining motion data from the one or more motion sensors, determining one or more features of the motion data, and calculating a probability that a step was made by the user, where the probability is based on at least one feature of the one or more features, and information indicative of the user's movement at a time prior to the first time interval.

The mobile device also can include one or more of the following features. The processing unit further can be configured to determine a motion state indicative of a type of the user's movement, and calculate the probability that a step was made further based on the motion state. The processing unit further can be configured to calculate the probability wherein the information indicative of the user's movement at a time prior to the first time interval comprises a data model indicative of the user's movement at a second time interval previous to the first time interval, and update the data model based on the motion data. The processing unit further can be configured to use a data model to determine a pattern of the one or more features, and calculate the probability that a step was made further based on the pattern. The data model can include a hidden Markov model.

The mobile device additionally or alternatively can include one or more of the following features. The processing unit further can be configured to use the one or more features indicative of at least one of a rate of change in acceleration, a magnitude of a change in acceleration, or a rate at which peaks in acceleration are detected. The processing unit further can be configured to access a probability that motion data over a previous interval corresponds to a step, and calculate the probability that a step was made over the first time interval at least partially based on the probability that motion data over a second time interval, previous to the first time interval, corresponds to a step. The processing unit further can be configured to provide the probability that a step was made to an application executed by the mobile device and/or estimate a timestamp indicative of a point in time, during the first time interval, that corresponds to the probability that a step was made.

An example computer-readable storage medium, according to the disclosure, has instructions embedded thereon for providing step detection. The instructions include computer-executable code for obtaining motion data indicative of a user's movement during a first time interval, determining one or more features of the motion data, and calculating a probability that a step was made, where the probability is based on at least one feature of the one or more features, and information indicative of the user's movement at a time prior to the first time interval.

The computer-readable storage medium also can include computer-executable code for providing one or more of the following features. Determining a motion state indicative of a type of the user's movement, and calculating the probability that a step was made further based on the motion state. Calculating the probability wherein the information indicative of the user's movement at a time prior to the first time interval comprises a data model indicative of the user's movement at a second time interval previous to the first time interval, and updating the data model based on the motion data. Using a data model to determine a pattern of the one or more features, and calculating the probability that a step was made further based on the pattern. Using the data model can include using a hidden Markov model.

The computer-readable storage medium additionally or alternatively can further include computer-executable code for providing one or more of the following features. Using the one or more features indicative of at least one of a rate of change in acceleration, a magnitude of a change in acceleration, or a rate at which peaks in acceleration are detected. Accessing a probability that motion data over a previous interval corresponds to a step, and calculating the probability that a step was made over the first time interval at least partially based on the probability that motion data over a second time interval, previous to the first time interval, corresponds to a step. Providing the probability that a step was made to an application executed by a mobile device. Obtaining the motion data comprises computer-executable code for receiving the motion data at a server. Sending the probability that that a step was made to a mobile device. Estimating a timestamp indicative of a point in time, during the first time interval, that corresponds to the probability that a step was made.

An example apparatus, according to the disclosure, can include means for obtaining motion data indicative of a user's movement during a first time interval, means for determining one or more features of the motion data, and means for calculating a probability that a step was made, wherein the probability is based on at least one feature of the one or more features, and information indicative of the user's movement at a time prior to the first time interval.

The apparatus also can include one or more of the following features. The means for calculating the probability that a step was made further include means for basing the calculation on the motion state. The means for calculating the probability can include means for basing the calculation on the information indicative of the user's movement at a time prior to the first time interval comprising a data model indicative of the user's movement at a second time interval previous to the first time interval, the apparatus further comprising, and the apparatus can further include means for updating the data model based on the motion data. The apparatus can further include means for using a data model to determine a pattern of the one or more features, where the means for calculating the probability that a step was made further include means for basing the calculation on the pattern. Means for using the data model can include means for using a hidden Markov model.

The apparatus additionally or alternatively can include one or more of the following features. The means for calculating the probability further include means for using the one or more features indicative of at least one of: a rate of change in acceleration, a magnitude of a change in acceleration, or a rate at which peaks in acceleration are detected. The apparatus can include means for accessing a probability that motion data over a previous interval corresponds to a step where the means for calculating the probability that a step was made over the first time interval include means for least partially basing the calculation on the probability that motion data over a second time interval, previous to the first time interval, corresponds to a step. The apparatus can also include means for providing the probability that a step was made to an application executed by a mobile device. The means for obtaining the motion data can include means for receiving the motion data at a server. The apparatus can further include means for sending the probability that a step was made to a mobile device, and/or means for estimating a timestamp indicative of a point in time, during the first time interval, that corresponds to the probability that a step was made.

Items and/or techniques described herein may provide one or more of the following capabilities, as well as other capabilities not mentioned. Techniques can provide for increased step determination accuracy, which, in turn, can improve the accuracy of applications utilizing a pedometer, such as fitness and health monitoring, dead reckoning for positioning applications, and the like. Embodiments can also provide more flexibility to an application by providing (e.g., via an application programming interface (API)) a probability of a step, rather than a simple binary output. These and other embodiments, along with many of its advantages and features, are described in more detail in conjunction with the text below and attached figures.

### BRIEF DESCRIPTION OF THE DRAWINGS

FIGS. 1A-1D are graphs plotting inertial sensor data, illustrating how sensed acceleration can vary depending on activity of the user and location of the mobile device.

FIG. 2 is a simplified illustration of an embodiment of a system that can utilize the techniques described herein.

FIG. 3 is an acceleration plot 300 showing acceleration data from which step detection probabilities may be determined, according to one embodiment.

FIG. 4 is a graph illustrating probabilistic outputs for motion sensed by a mobile device, according to one embodiment.

FIG. 5 is a graph illustrating how hidden Markov model (HMM) smoothing or similar algorithms can be applied.

FIG. 6 is a simplified flow chart that illustrates how state detection may be utilized in a process utilizing the step-detection calculations described herein, according to one embodiment.

FIG. 7 is a simplified flow diagram of a process for step detection, according to one embodiment.

FIG. 8 illustrates an embodiment of a mobile device.

### DETAILED DESCRIPTION

The following description is provided with reference to the drawings, where like reference numerals are used to refer to like elements throughout. While various details of one or more techniques are described herein, other techniques are also possible. In some instances, structures and devices are shown in block diagram form in order to facilitate describing various techniques.

“Instructions” as referred to herein relate to expressions which represent one or more logical operations. For example, instructions may be “machine-” or “computer-executable” by being interpretable by a machine, computer, and/or processor for executing one or more operations on one or more data objects. However, this is merely an example of instructions and claimed subject matter is not limited in this respect. In another example, instructions as referred to herein may relate to encoded commands which are executable by a processing unit having a command set which includes the encoded commands. Such an instruction may be encoded in the form of a machine language understood by the processing unit. Again, these are merely examples of an instruction and claimed subject matter is not limited in this respect.

Inertial sensor-based step detectors are utilized in a variety of applications, such as fitness and health monitoring, dead reckoning for fire-fighters, and more. In most applications, the sensors are placed in a constrained position with respect to the user. For example sensors are attached to the waist, wrist, shoes, etc., of a user. Because of the prevalence of inertial sensors in mobile devices such as mobile phones, portable media players, gaming devices, and other portable electronics, these mobile devices can also be used to estimate the number of steps taken by a user. However, the phone is not held in a constrained position, and as a result, the inertial sensors can measure the combined motion due to steps and other activities such as fidgeting, swinging of hand while walking, and the like.

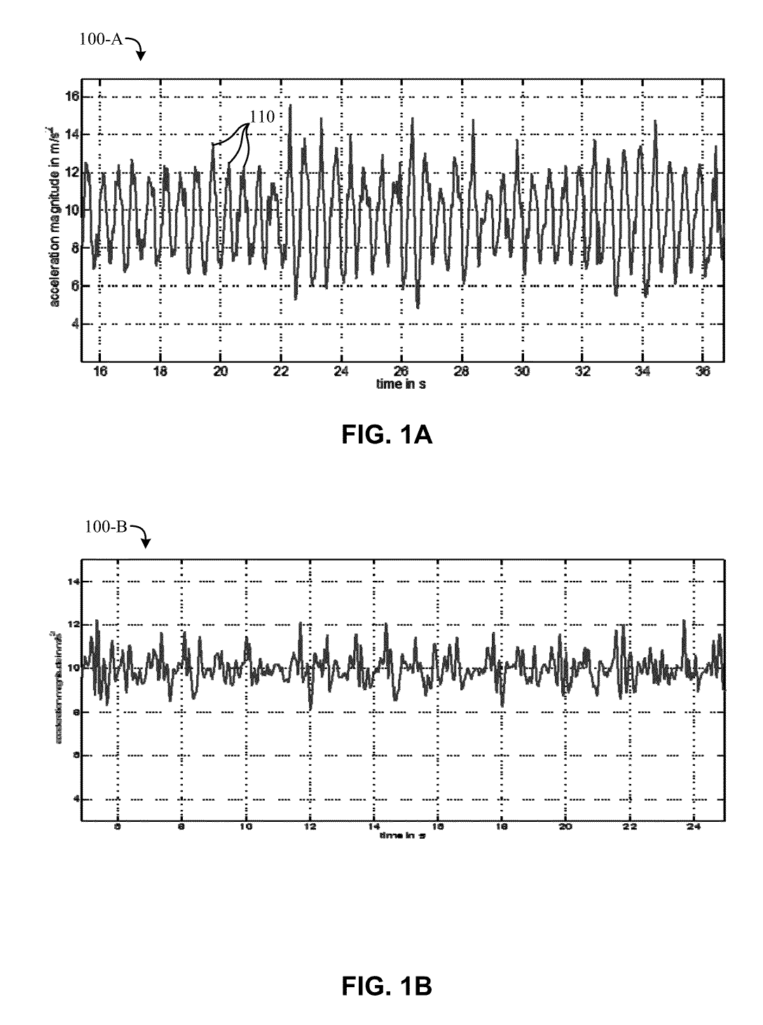

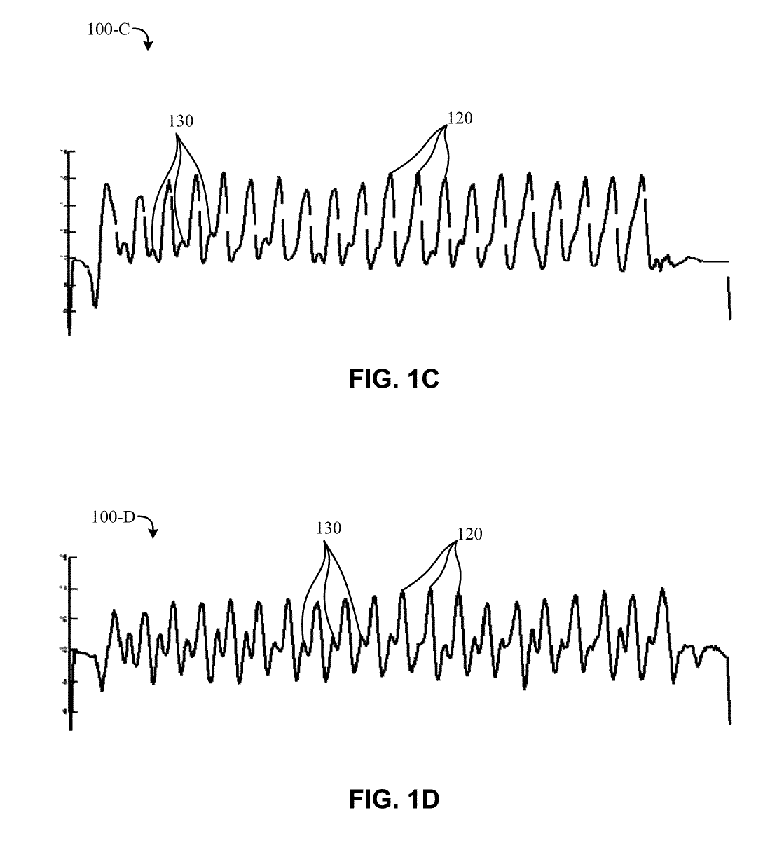

FIGS. 1A-1D are graphs 100 plotting inertial sensor data, illustrating how sensed acceleration can vary depending on activity of the user and location of the mobile device. The graph 100-A shown in FIG. 1A illustrates example total acceleration magnitude data sensed by a mobile device at the waist of a user when a user is engaged in a steady walk (at approximately two steps per second). The data illustrates variations in acceleration, peaking at roughly 2-5 meters per second squared (m/s²), centered at gravitational acceleration (approximately 9.8 m/s²). Here, the data is relatively straightforward: each peak 110 (ignoring smaller peaks that may appear on a larger one) corresponds to a step taken by the user. (Note: for simplicity, only a small subset of the peaks 110, 120, and 130 of the graphs 100 of FIGS. 1A-1D are labeled.)

FIG. 1B illustrates another graph 100-B, with axes similar to those provided in FIG. 1A. In this example, the user has the mobile device in the same position (e.g., waist) as in the graph 100-A of FIG. 1A. Here, however, the user is walking slowly and gently, at pace of approximately one step per second. The data illustrates acceleration peaks of roughly 2 m/s² or less, with no clearly distinguishable pattern. Accordingly, unlike the graph 100-A of FIG. 1A, there is no clear correlation between acceleration peaks and steps taken by a user.

FIG. 1C illustrates another graph 100-C, illustrating measured acceleration magnitude over time, similar to FIGS. 1A and 1B. In this example, the mobile device is in swinging back and forth in the user's hand while the user is walking at a fast pace. Here, the acceleration data has a more distinguishable pattern than the graph 100-B of FIG. 1B. However, large peaks 120 due to the swinging of the user's hand can often mask smaller peaks 130 that correlate with a user's steps. In graph 100-C, a single large peak 120 can mask two smaller peaks 130. In other words, each large peak 120 correlates to two steps taken by the user.

FIG. 1D illustrates a similar graph 100-D, in which the mobile device is in swinging back and forth in the user's hand while the user is walking at a slower pace relative to graph 100-C. In this example, the larger peaks 120 are more likely to mask just one smaller peak 130 that correlates to a step rather than two. In this case, the number of small and large peaks together gives the accurate step count.

Because sensor data can vary significantly based on conditions such as the location of a mobile device relative to a user, and a user's activity (walking, running, etc.), it can be difficult to decipher steps taken from movement due to other activities. As a result, pedometers available on mobile devices can be highly inaccurate. This can further result in poor performance of applications that rely on pedometer data to determine additional information (e.g., dead reckoning for position determination). However, accuracy of positioning and/or other applications dependent on pedometer functionality can be improved when using information about the uncertainty in step detection. Accordingly, techniques provided herein allow for probabilistic step detection using accelerometer data, instead of or in addition to a binary (“step” or “no step”) output. Techniques described herein can further improve accuracy by adapting to a particular user, using an algorithm that adapts to different walking gaits and different users. Furthermore, techniques may provide for state-based step detection that detects a user's motion state (e.g., at rest (sitting, standing, etc.) walking, running, walking and swinging (or performing another arm movement), fidgeting, etc.) that can significantly impact step detection and modifies step detection accordingly.

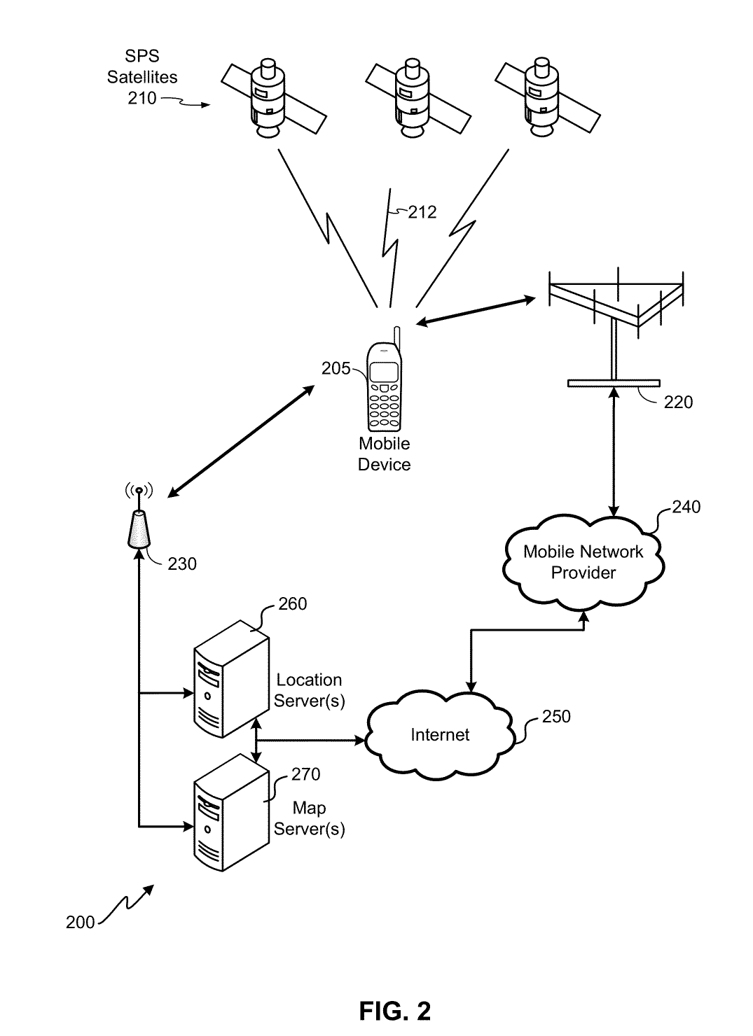

FIG. 2 is a simplified illustration of an embodiment of a system 200 that can utilize the techniques described herein. A mobile device 205 and/or other components of the system 200 can process various data points to determine the position of the mobile device 205. Such data points can step probabilities using the techniques described herein below. The system 200 can include a mobile device 205, satellite positioning service (SPS) satellites 210, base transceiver station(s) 220, mobile network provider 240, access point(s) 230, location server(s) 260, map server(s) 270, and the Internet 250. It should be noted that FIG. 2 provides only a generalized illustration of various components, any or all of which may be utilized as appropriate. Moreover, different components may be added, omitted, combined, and/or separated, as desired. A person of ordinary skill in the art will recognize many modifications to the components illustrated. Furthermore, the system 200 illustrated in FIG. 2 is provided as an example system in which step detection techniques provided herein can be used for determining the position of the mobile device. However, embodiments are not so limited. Step detection techniques provided herein can be utilized in a variety of devices other than the mobile device 205 of FIG. 2, and for a variety of applications other than positioning.

In the system 200, a location of the mobile device 205 can be determined a variety of information. For example, the location of the mobile device 205 can be calculated using triangulation and/or other positioning techniques with information transmitted from SPS satellites 210. In these embodiments, the mobile device 205 may utilize a receiver specifically implemented for use with the SPS that extracts position data from a plurality of signals 212 transmitted by SPS satellites 210. Transmitted satellite signals may include, for example, signals marked with a repeating pseudo-random noise (PN) code of a set number of chips and may be located on ground based control stations, user equipment and/or space vehicles. Satellite positioning systems may include such systems as the Global Positioning System (GPS), Galileo, Glonass, Compass, Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like.

Embodiments may also use communication and/or positioning capabilities provided by base transceiver stations 220 and mobile network provider 240 (e.g., a cell phone service provider), as well as access point(s) 230. Communication to and from the mobile device 205 may thus also be implemented, in some embodiments, using various wireless communication networks. The mobile network provider 240, for example, can comprise such as a wide area wireless network (WWAN). The access point(s) 230 can be part of a wireless local area network (WLAN), a wireless personal area network (WPAN), and the like. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may implement Long Term Evolution (LTE), LTE Advanced, and so on. LTE, LTE Advanced, GSM, and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may also be an IEEE 802.11x network, and a WPAN may be a Bluetooth network, an IEEE 802.15x, or some other type of network. The techniques described herein may also be used for any combination of WWAN, WLAN and/or WPAN.

Mobile network provider 240 and/or access point(s) 230 can further communicatively connect the mobile device 205 to the Internet 250. Other embodiments may include other networks in addition, or as an alternative to, the Internet 250. Such networks can include any of a variety of public and/or private communication networks, including wide area network (WAN), local area network (LAN), and the like. Moreover, networking technologies can include switching and/or packetized networks utilizing optical, radio frequency (RF), wired, satellite, and/or other technologies. The access point(s) 230 can be part of a WLAN that operates in a building to perform communications over smaller geographic regions than a WWAN. The access point(s) 230 can be part of a WiFi network (802.11x), cellular piconets and/or femtocells, Bluetooth network, and the like. The access point(s) 230 can also form part of a Qualcomm indoor positioning system (QUIPSTM). Embodiments may include any number of access point(s) 230, any of which may be a moveable node, or may be otherwise capable of being relocated.

In addition to the various components of the system 200 illustrated in FIG. 2, the mobile device 205 can utilize data from internal components to assist in position determination. For example, the mobile device 205 can include a variety of sensors, such as gyroscopes, accelerometers, magnetometers, and others. As indicated above such sensors can be utilized in step detection for a pedometer, which can complement and/or further improve the accuracy of location determinations. Such internal sensors can be particularly beneficial for positioning when the SPS receiver of the mobile device 205 is unable to receive sufficient information from SPS satellites for a position determination, such as in indoor environments. The sensor data can be provided to an application on the mobile device 205 and/or another device of the system 200 (e.g., location server(s) 260) for step detection calculations.

Optionally, sensor data can be provided by one or more sensors that are physically separate from the mobile device 205. These sensor(s) can be communicatively coupled with the mobile device 205 and/or another device of the system 200 (e.g., location server(s) 260) via, for example, low-power wireless technologies, such as Bluetooth low energy, ANT+, ZIGBEE (and/or other technologies based on the IEEE 802.15.4 standard), and the like, which can help preserve energy for battery-powered sensor(s). Depending on the sensor(s) utilized, the sensor(s) can communicate raw sensor information and/or provide information resulting from processing raw sensor information to at least some degree.

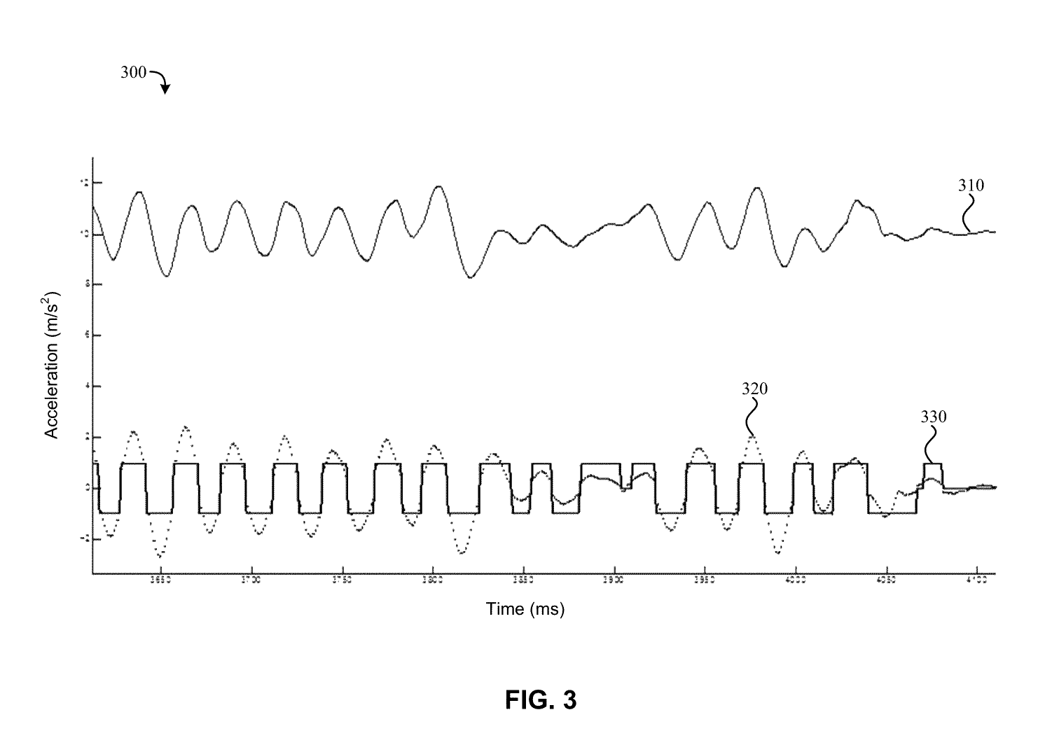

FIG. 3 is an acceleration plot 300 showing acceleration data from which step detection probabilities may be determined, according to one embodiment. Raw acceleration data 310, similar to the acceleration data of FIGS. 1A-1D, is gathered from acceleration magnitude detected by one or more sensors of a mobile device. From this raw acceleration data 310, an acceleration spread 320 can be calculated, providing a measure of variance in the acceleration data over a period of time. For example, acceleration spread 320 may be calculated as the difference in maximum and minimum acceleration measurements for a window of time (e.g., 0.1 seconds, 0.2 seconds, 0.3, seconds, etc.) A peak detection algorithm can then be used to provide peak-detection data 330 that indicates when peaks (maximum local values) and valleys (minimum local values) are detected in the acceleration spread 320.

Each peak in the peak-detection data 330 can be indicative of a potential step. However, rather than simply providing a binary output (e.g., indicating a “step” for each detected peak), a probability of whether a step was taken can be calculated for each peak (or a subset of the peaks), based on measured and/or calculated features of the peak and other data. For example, a Bayesian probability that a step was taken for a given peak having an acceleration spread (i.e., magnitude of acceleration change between a peak and an adjacent valley of the raw acceleration data 310) and time elapsed since the previous peak, Δₜ, using the equation:

$$P ( step \vert spread , {Δ}_{t} ) = \frac{P ( spread \vert step ) \cdot P ( {Δ}_{t} \vert step ) \cdot P ( step )}{P ( spread , {Δ}_{t} )} \qquad ( 1 )$$

Here, acceleration spread and Δₜ, are considered independent features of a peak that can be separated in the right-hand side of Equation (1). Accordingly, the numerator separates these features and multiplies the probabilities of observing each feature (i.e., the probability of obtaining the measured and/or calculated value of each feature), given a step was taken, with the prior probability that a step was taken. The denominator is the probability of observing the value of these features regardless of whether a step was taken.

Probabilities for the components of Equation (1), such as the probability of observing a particular acceleration spread can be modeled, based on measurements. Accordingly, there can be data models for the various features, given a step was taken, as well as data models for features, given that no step was taken (as would be used in determining the probability of observing the value of these features regardless of whether a step was taken). Data models can include step functions and/or similar features in which a probability increases or decreases based on whether a measured value meets or exceeds a threshold value. (E.g., if a measured value of a particular acceleration spread meets or exceeds a threshold value, a probability increases from 0.5 to 1.0.) The granularity of such step functions and/or their associated probabilities can vary, depending on desired functionality.

Data models can further be based on historical data of a mobile device, allowing for the probabilistic step detection to adapt to the particular motions of a user. Where no historical data is available, generic data models can be used for probability determinations. However, as historical data is gathered over time, thresholds and/or other features of these generic data models can be adjusted to more accurately determine the steps of a user, enabling the probabilistic step detection to adjust step detection probabilities to a user that, for example walks slowly and gently (as shown in FIG. 1B) rather than more steadily (as shown in FIG. 1A). Where multiple users use a mobile device, the mobile device can be configured to allow a user to “login” and/or otherwise provide identification to allow motion data to be associated with that particular user. Other embodiments may automatically determine a user based on movement and/or other sensed data.

Data models utilized in probabilistic step determination can be adjusted by analyzing the historical data in a variety of ways. For example, if an average peak value of historical data is determined to be less than average, the data model could be adjusted to lower a threshold for a probability related to peak values. (E.g., a probability increases from 0.5 to 1.0 if a measured value of a particular peak exceeds a threshold value of 11 m/s² rather than 12 m/s².) The data models can be similarly adjusted to adapt to other features (peak slope, rate, etc.) of the historical data.

Of course, calculating the probability that a step was taken can vary, depending on desired functionality. The probability can be calculated using a framework other than the Bayesian framework of Equation (1). Furthermore, probabilities can be based on any of a variety of peak features, including features other than acceleration spread or peak width, such as slope and/or width of the peak. These and other features discussed herein can be extracted from the raw acceleration data 310 using acceleration spread 320 and/or peak-detection data 330. It will be understood, however, that acceleration and other motion features could be represented and/or calculated differently, which can depend on how the type(s) of data collection and/or abstraction. Furthermore, data “peaks” discussed herein representative of a particular way of interpreting motion data, for illustrative purposes. However, techniques disclosed herein can provide for calculating probabilities of any of a variety of motion features that can be determined from acceleration and/or other motion data.

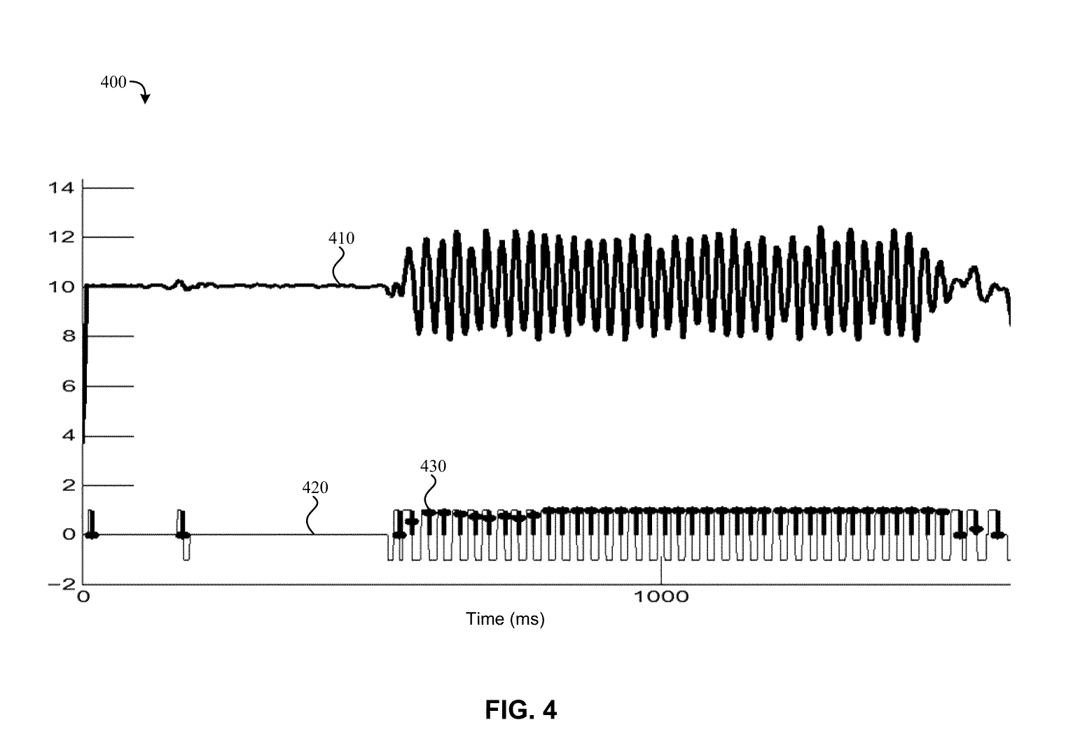

FIG. 4 is a graph 400 illustrating probabilistic outputs for motion sensed by a mobile device. In this graph, acceleration data 410 is provided in m/s², similar to the acceleration plots of FIGS. 1A-1D and 3. Furthermore, as with FIG. 3, peak-detection data 420 is derived from the acceleration data 410, indicating a series of peaks that may correlate to steps taken by a user. Correspondingly, a series of probabilities 430 is output, where each probability corresponds to a detected peak. Probabilities 430 can be based on a variety of data features, including particular features of respective peaks, as discussed previously. Acceleration spread and/or other calculations can be made to identify the peaks and/or other features. As indicated previously, depending on desired functionality and/or other factors, some embodiments may provide for determining a probability for a subset of a plurality of detected peaks. The series of probabilities 430 can be provided via an application programming interface (API) to an application, such as a software application executed by a processing unit of the mobile device.

In some embodiments, there may be some latency between when motion data is measured and when a corresponding probability based on the motion data is calculated. The tolerance for such latency may vary, depending on the application to which the series of probabilities 430 are provided. The application may indicate a tolerance threshold for such latency via and API.

Where some latency is tolerated, hidden Markov model (HMM) smoothing, probability averaging, and/or other pattern recognition algorithms may be utilized to further increase the accuracy of step detection over a window of time by exploiting the continuity of typical, paced walking. In other words, because walking typically involves a steady pattern of steps, it is more likely that that a person took a step during a brief moment in which a pattern of steps was interrupted.

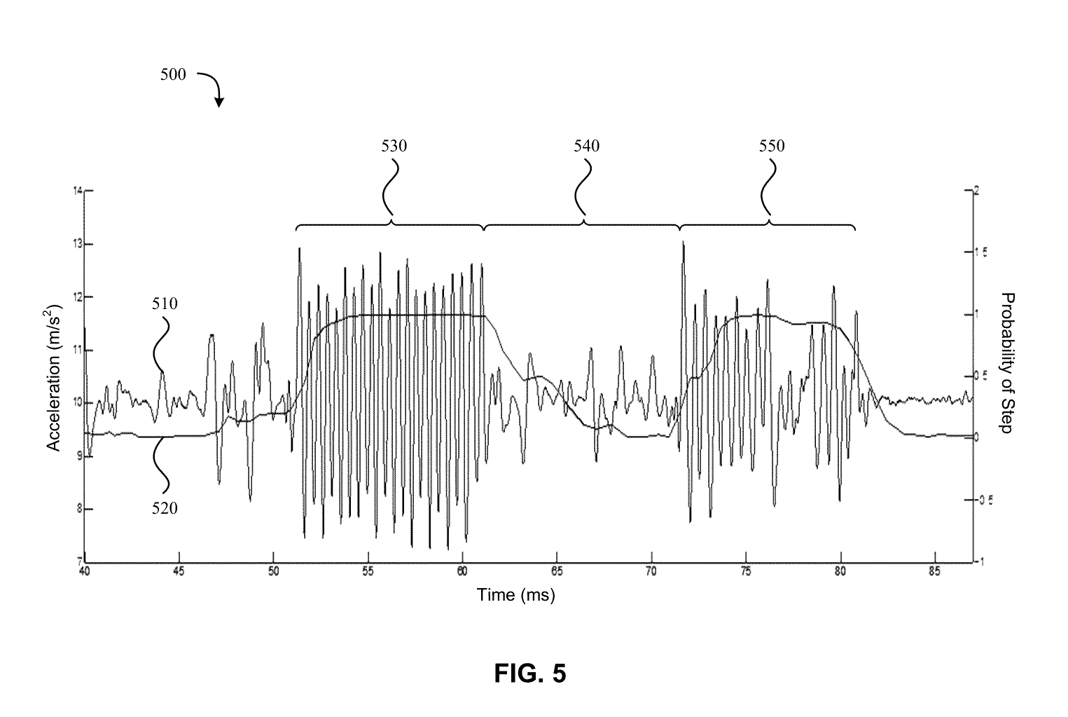

FIG. 5 is a graph 500 illustrating how such HMM smoothing or similar algorithms can be applied. The graph 500 includes acceleration data 510 and associated probabilities 520 a step was taken. (It can be noted that, rather than a series of probabilities 430 as provided in FIG. 4, the probabilities 520 of FIG. 5 are shown as a continuous line.) Rather than base each probability on a particular peak of the acceleration data 510, HMMs and/or other data models encapsulate a pattern of data features over a window of time and smooth probability calculations for interruptions in the pattern of data. For instance, for a first period of time 530 in which the acceleration data 510 includes regular peaks that may be indicative of steps, the corresponding probabilities that steps are taken at the beginning of the first period of time 530 gradually increase, rather than abruptly increase. Similarly, probabilities at the beginning of a second period of time 540, following the first period of time 530, in which acceleration peaks occur with less frequency and magnitude, gradually decrease, rather than abruptly decrease. A similar pattern is followed during a third period of time 550 in which the acceleration data 510 includes somewhat regular peaks. As can be seen, small fluctuations during periods in which probabilities that a step is taken is either relatively high or relatively low are “smoothed” over, thereby increasing accuracy based on the pattern-based nature of walking. Such smoothing can be based on probabilities 520 and/or the acceleration data 510 itself during a window of time, depending on the data-smoothing mechanisms utilized.

The degree of smoothing can vary depending on desired functionality and an application's tolerance for latency, among other factors. In some embodiments, HMM smoothing can be run backwards on a short time window to smooth the calculated probabilities. Furthermore, this smoothing window may be adapted to a particular user using adaptability techniques described above. Other data-smoothing mechanisms can be used in addition or as an alternative to HMM smoothing.

The degree of HMM smoothing and/or the way in which step-detection probabilities are calculated may be impacted by a determined state of the user, which (as illustrated in FIGS. 1A-1D) can drastically impact the acceleration data from which steps-detection probabilities are calculated. This allows a mobile device to dynamically adjust to a state of the user for more accurate step-detection probabilities.

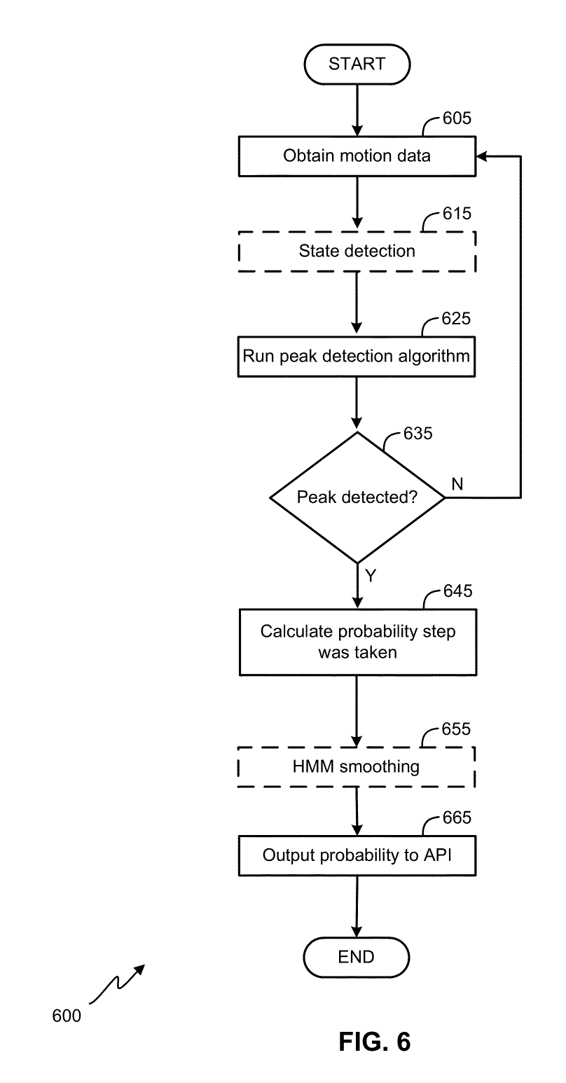

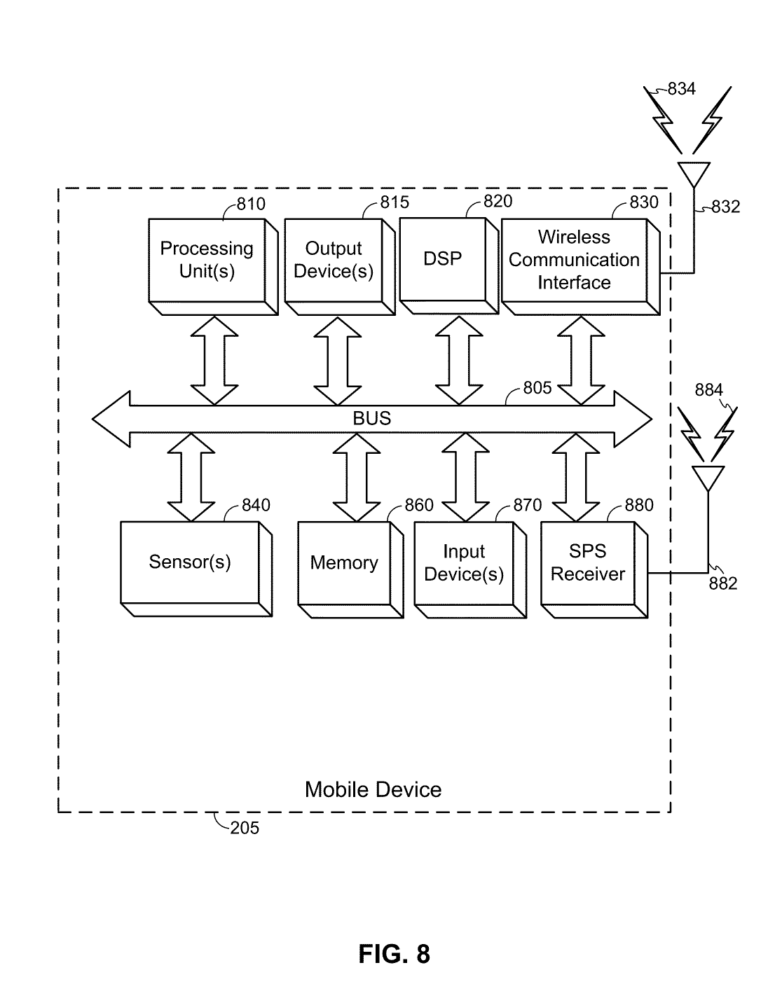

FIG. 6 is a simplified flow chart 600 that illustrates how state detection may be utilized in a process utilizing the step-detection calculations described herein, according to one embodiment. Each block illustrated in the process can be performed by hardware and/or software components of a mobile device, such as the mobile device shown in FIG. 8. For example, the step-detection software application may be executed by a processing unit, memory, and/or similar means. Additionally or alternatively, some or all components shown in the simplified flow chart 600 may be performed by one or more separate devices communicatively coupled with the mobile device (e.g., the location server(s) 260 of FIG. 2). A person of ordinary skill in the art will recognize many alterations, substitutions, and variations.

At block 605, the process can begin by obtaining motion data from one or more sensors. The motion data can be obtained, for example, by a software application via an API. Such an API not only can provide motion data (e.g., time-stamped acceleration data, such as is shown in FIGS. 1A-1D and 3-4), but additional information that can be utilized as well, including base stride length estimate of a user, a maximum allowed reporting latency, and the like.

At block 615, the process can optionally include state detection. Here, motion data can be broadly analyzed to determine a state (walking, running, etc.) that the user is currently in, to help increase the accuracy of subsequent step-detection probability calculations. For example, motion data over a period of time may be analyzed to determine whether the user is in a recognizable state such as steady-state walking (as shown in FIG. 1A), walking and swinging hand (as shown in FIG. 1C), and the like.

State detection may vary, according to various embodiments. For example, for embodiments in which the state of a user may not impact a peak detection algorithm, or in which state detection utilizes peak detection, state detection can occur after peak detection. Additionally or alternatively, a state may be calculated using an application and/or function separate from a pedometer and obtained via an API. In such embodiments, the state may be obtained from off-the-shelf software and/or hardware applications, including built-in functionality of the mobile device, which can perform an in-depth contextual analysis to accurately determine a state of the user. Depending on the application used, the contextual analysis can utilize a wide variety of information such as determined location, time of day, sensor data (e.g., motion, light, sound, etc.), historical contextual determinations, and the like.

At block 625 a peak detection algorithm is run. The peak detection can utilize any of a variety of traditional techniques utilized in pedometers. Depending on the technique used, peak detection may involve deriving additional information from the motion data, such as the acceleration spread 320 described in relation to FIG. 3. At block 635, if no peak is detected, the process returns to block 605 to obtain and analyze more motion data.

If a peak is detected, the process can continue to block 645, where the probability a step was taken is calculated. As indicated previously, the probability can be based on one or more data models (e.g., data models describing the probabilities of certain features of the motion data for a step and/or no step), which can adapt to a user based on historical data. Furthermore, for embodiments utilizing state detection, these probabilistic models can vary from state to state. As such, not only can step-detection calculation techniques adapt to a particular user, but they can also adapt to each state that a user might be in, further increasing the accuracy of step detection.

At block 655 HMM smoothing is optionally performed. As illustrated above in regard to FIG. 5, HMM smoothing can adjust the probability calculated at 645 to account for motion data over a window of time (e.g., 4 seconds prior to the peak detected at block 635). Other data smoothing techniques, such as averaging, low-pass filtering, linear smoothing, and the like, can be implemented additionally or alternatively. Depending on desired functionality and/or the type of smoothing used, embodiments may incorporate smoothing into other aspects of the process, rather than after the probability is calculated. For example, smoothing may be incorporated into the probability calculation at block 645.

At block 665, the probability is output to the API. Here, depending on desired functionality, the API may provide additional information besides the step probability, which may be utilized by different applications in different ways. This additional information can include, for example, a time stamp, step event, step probability history (up to a desired number of steps), a step rate, a stride length adjusted for step rate, and the like. The algorithm may also provide estimates of timestamps at which peaks corresponding to steps were not observed in the data. An example of such a scenario, as discussed above, is shown in FIG. 1C, where the peaks 120 overshadow smaller peaks 130.

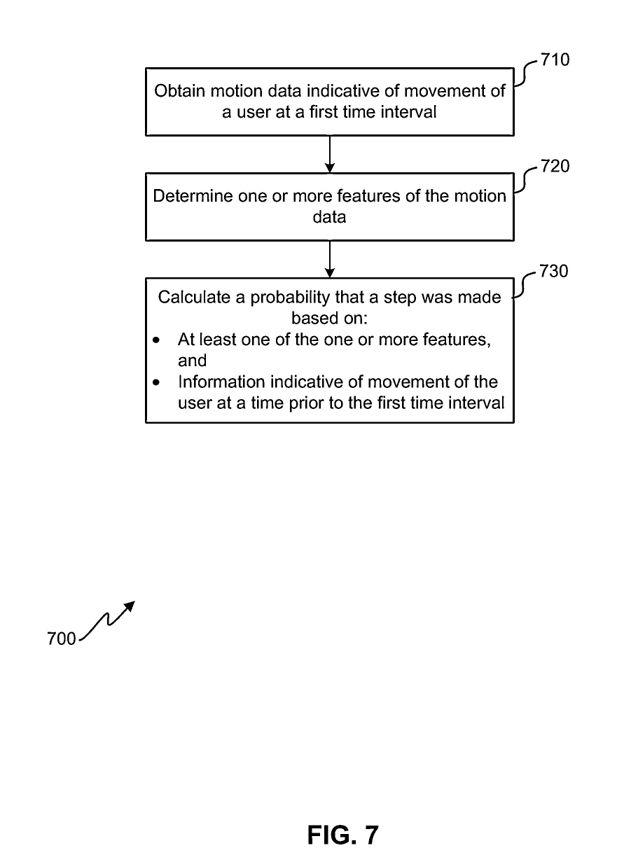

FIG. 7 is a simplified flow diagram of a process 700 for step detection, according to one embodiment. In some aspects, the process 700 of FIG. 7 is a process for implementing one or more components of the process 600 of FIG. 6, such as block 645: calculating the probability a step was taken. Similar to the process 600 of FIG. 6, the process 700 of FIG. 7, can be executed by software and/or hardware components of a mobile device and/or other device communicatively coupled thereto, such as a computer server. Means for performing some or all blocks shown in FIG. 7 can include, for example, specialized and/or generalized hardware programmed and/or otherwise configured to perform the components shown, in addition to any further means discussed below. Many such means are described in further detail below with regard to FIG. 8.

At block 710, the process includes obtaining motion data indicative of a user's movement at a first time interval. The motion data can include data from one or more sensors of a mobile device. Motion data can include, among other things, acceleration magnitude as described herein. Although embodiments described previously include software and/or hardware of a mobile device obtaining such movement data, embodiments can include sending motion data from a mobile device to a server (e.g., a location server 260 of FIG. 2). Accordingly, means for obtaining the motion data not only can include software and/or hardware components for executing an application (e.g., an API executed by a processing unit and a memory), but also a communication interface and/or similar means.

At block 720, one or more features of the motion data is/are determined. As indicated previously, features can include any of a variety of measureable features that can impact a step-detection probability calculation, such as peak slope, width, rate (e.g., time since last peak), acceleration spread, rate of acceleration change, and the like. Again, means for determining one or more features of the motion can include software and/or hardware components for executing an application and/or similar means, such as described below in regards to FIG. 8.

At block 730, a probability that a step was made is calculated, based on at least one of the one or more features and information indicative of the user's movement at a time prior to the first interval. A probabilistic calculation can be made using one or more probabilistic models that provide a probability that the at least one feature is observed, given that a step was made, or that no step was made. Information indicative of the user's movement at a time prior to the first time interval could be, for example, a prior probability that a step was taken, a window of time for which data smoothing is determined, a determined motion state, a probabilistic model based on historical data, or the like. Means for calculating the probability that a step was made can include software and/or hardware components for executing an application and/or similar means, such as described below in regards to FIG. 8.

It should be appreciated that the specific steps illustrated in FIG. 7 provide an example process 700 for step detection. Alternative embodiments may include alterations to the embodiments shown. Furthermore, additional features may be added or removed depending on the particular applications. For example, embodiments may include using data models, such as an HMM, to determine a pattern of the one or more features and calculate the probability accordingly. Additionally or alternatively, embodiments may include providing the probability to an application executed by a mobile device and/or updating probabilistic models based on the probability. One of ordinary skill in the art would recognize many variations, modifications, and alternatives.

FIG. 8 illustrates an embodiment of a mobile device 205, which can be configured to perform the methods provided by various other embodiments, such as those described in relation to FIGS. 6 and 7. It may also be utilized in the system 200 of FIG. 2, in some embodiments. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

It can also be noted that some or all of the components of the mobile device 205 shown in FIG. 8 can be utilized in other devices described herein, such as location server(s) 260, map server(s) 270, and/or access point(s) 230 of FIG. 2. In these other devices, as well as the mobile device 205, it can be noted that at least some components illustrated by FIG. 8 can be distributed among various networked devices, which may be disposed at different physical locations, rather than localized to a single device.

The mobile device 205 is shown comprising hardware elements that can be electrically coupled via a bus 805 (or may otherwise be in communication, as appropriate). The hardware elements may include a processing unit(s) 810 which can include without limitation one or more general-purpose processors, one or more special-purpose processors (such as digital signal processors (DSP), graphics acceleration processors, application specific integrated circuits (ASICs), and/or the like), and/or other processing structure or means, which can be configured to perform one or more of the methods described herein, including methods illustrated in FIGS. 6 and 7. As shown in FIG. 8, some embodiments may have a separate DSP 820, depending on desired functionality. The mobile device 205 also can include one or more input devices 870, which can include without limitation a touch screen, a touch pad, microphone, button(s), dial(s), switch(es), and/or the like; and one or more output devices 815, which can include without limitation a display, light emitting diode (LED), speakers, and/or the like.

The mobile device 205 might also include a wireless communication interface 830, which can include without limitation a modem, a network card, an infrared communication device, a wireless communication device, and/or a chipset (such as a Bluetooth™ device, an IEEE 802.11 device, an IEEE 802.15.4 device, a WiFi device, a WiMax device, cellular communication facilities (as described above), etc.), and/or the like. The wireless communication interface 830 may permit data to be exchanged with a network (such as the Internet 250 and/or mobile network provider 240 of FIG. 2), other computer systems, and/or any other electronic devices described herein. The communication can be carried out via one or more wireless communication antenna(s) 832 that send and/or receive wireless signals 834. Depending on desired functionality, the mobile device 205 can include separate transceivers to communicate with base transceiver stations and access points.

The mobile device 205 can further include sensor(s) 840. As indicated herein, sensor(s) 840 can include motion sensors for measuring and providing motion data shown in FIGS. 1A-1D, and 3-5, and used in the processes illustrated in FIGS. 6 and 7. These motion sensors can include, without limitation, one or more accelerometers, gyroscopes, cameras, magnetometers, altimeters, and the like. The sensor(s) 840 can include other sensors as well, such as one or more microphones, proximity sensors, light sensors, and the like.

Embodiments of the mobile device may also include an SPS receiver 880 capable of receiving signals 884 from one or more SPS satellites (such as the SPS satellites 210 of FIG. 2) using an SPS antenna 882.

The mobile device 205 may further include (and/or be in communication with) a memory 860. The memory 860 can include a computer-readable (or “machine-readable”) storage medium including, without limitation, a local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The memory 860 of the mobile device 205 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above, such as those described in relation to FIGS. 6 and 7, might be implemented as code and/or instructions executable by the mobile device 205 (and/or a processing unit within a mobile device 205) (and/or another device of a positioning system). In an aspect, then, such code and/or instructions can be used to configure and/or adapt a general purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a mobile device (such as the mobile device 205) to perform methods in accordance with various embodiments of the invention. According to a set of embodiments, some or all of the procedures of such methods are performed by the mobile device 205 in response to processing unit(s) 810 executing one or more sequences of one or more instructions (which might be incorporated into an operating system and/or other code) contained in the memory 860. Merely by way of example, execution of the sequences of instructions contained in the memory 860 might cause the processing unit(s) 810 to perform one or more procedures of the methods described herein. Additionally or alternatively, portions of the methods described herein may be executed through specialized hardware.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method of step detection comprising:
obtaining motion data indicative of a user's movement during a first time interval;
determining one or more features of the motion data; and
calculating, with a processing unit, a probability that a step was made, wherein the probability is based on:
at least one feature of the one or more features, and
information indicative of the user's movement at a time prior to the first time interval.

2. The method of claim 1, further comprising determining a motion state indicative of a type of the user's movement, wherein calculating the probability that a step was made is further based on the motion state.

3. The method of claim 2, wherein the motion state is indicative of at least one of:
standing,
sitting,
running,
fidgeting,
walking,
swinging or dangling a mobile device in hand, or
the user's movement.

4. The method of claim 1, wherein the information indicative of the user's movement at a time prior to the first time interval comprises a data model indicative of the user's movement at a second time interval previous to the first time interval, and wherein the method further comprises updating the data model based on the motion data.

5. The method of claim 1, further comprising using a data model to determine a pattern of the one or more features, wherein calculating the probability that a step was made is further based on the pattern.

6. The method of claim 5 wherein the data model comprises a hidden Markov model.

7. The method of claim 1, wherein the one or more features is indicative of at least one of:
a rate of change in acceleration,
a magnitude of a change in acceleration, or
a rate at which peaks in acceleration are detected.

8. The method of claim 1, further comprising accessing a probability that motion data over a previous interval corresponds to a step, wherein calculating the probability that a step was made over the first time interval is at least partially based on the probability that motion data over a second time interval, previous to the first time interval, corresponds to a step.

9. The method of claim 1, wherein calculating a probability that a step was made is performed on a mobile device.

10. The method of claim 9, further comprising providing the probability that a step was made to an application executed by the mobile device.

11. The method of claim 1, wherein obtaining the motion data comprises receiving, at a server, the motion data.

12. The method of claim 11, further comprising sending the probability that a step was made to mobile device.

13. The method of claim 1, further comprising estimating a timestamp indicative of a point in time, during the first time interval, that corresponds to the probability that a step was made.

14. The method of claim 1, further comprising providing information indicative of at least one of
a time stamp,
a step event,
a step probability history,
a step rate, or
a stride length.

15. A mobile device comprising:
one or more motion sensors configured to measure motion data indicative of a user's movement of the mobile device during a first time interval; and
a processing unit coupled to the one or more motion sensors and configured to perform functions including:
obtaining motion data from the one or more motion sensors;
determining one or more features of the motion data; and
calculating a probability that a step was made by the user, wherein the probability is based on:
at least one feature of the one or more features, and
information indicative of the user's movement at a time prior to the first time interval.

16. The mobile device of claim 15, wherein the processing unit is further configured to:
determine a motion state indicative of a type of the user's movement, and
calculate the probability that a step was made further based on the motion state.

17. The mobile device of claim 15, wherein the processing unit is further configured to:
calculate the probability wherein the information indicative of the user's movement at a time prior to the first time interval comprises a data model indicative of the user's movement at a second time interval previous to the first time interval, and
update the data model based on the motion data.

18. The mobile device of claim 15, wherein the processing unit is further configured to:
use a data model to determine a pattern of the one or more features; and
calculate the probability that a step was made further based on the pattern.

19. The mobile device of claim 18, wherein the data model comprises a hidden Markov model.

20. The mobile device of claim 15, wherein the processing unit is further configured to use the one or more features indicative of at least one of:
a rate of change in acceleration,
a magnitude of a change in acceleration, or
a rate at which peaks in acceleration are detected.

21. The mobile device of claim 15, wherein the processing unit is further configured to:
access a probability that motion data over a previous interval corresponds to a step; and
calculate the probability that a step was made over the first time interval at least partially based on the probability that motion data over a second time interval, previous to the first time interval, corresponds to a step.

22. The mobile device of claim 15, wherein the processing unit is further configured to provide the probability that a step was made to an application executed by the mobile device.

23. The mobile device of claim 15, wherein the processing unit is further configured to estimate a timestamp indicative of a point in time, during the first time interval, that corresponds to the probability that a step was made.

24. A computer-readable storage medium having instructions embedded thereon for providing step detection, the instructions including computer-executable code for:
obtaining motion data indicative of a user's movement during a first time interval;
determining one or more features of the motion data; and
calculating a probability that a step was made, wherein the probability is based on:
at least one feature of the one or more features, and
information indicative of the user's movement at a time prior to the first time interval.

25. The computer-readable storage medium of claim 24, further comprising computer-executable code for:
determining a motion state indicative of a type of the user's movement, and
calculating the probability that a step was made further based on the motion state.

26. The computer-readable storage medium of claim 24, further comprising computer-executable code for:
calculating the probability wherein the information indicative of the user's movement at a time prior to the first time interval comprises a data model indicative of the user's movement at a second time interval previous to the first time interval, and
updating the data model based on the motion data.

27. The computer-readable storage medium of claim 24, further comprising computer-executable code for:
using a data model to determine a pattern of the one or more features; and
calculating the probability that a step was made further based on the pattern.

28. The computer-readable storage medium of claim 27, wherein the using the data model comprises computer-executable code for using a hidden Markov model.

29. The computer-readable storage medium of claim 24, wherein the wherein computer-executable code is further configured for using the one or more features indicative of at least one of:
a rate of change in acceleration,
a magnitude of a change in acceleration, or
a rate at which peaks in acceleration are detected.

30. The computer-readable storage medium of claim 24, further comprising computer-executable code for:
accessing a probability that motion data over a previous interval corresponds to a step; and
calculating the probability that a step was made over the first time interval at least partially based on the probability that motion data over a second time interval, previous to the first time interval, corresponds to a step.

31. The computer-readable storage medium of claim 24, further comprising computer-executable code for providing the probability that a step was made to an application executed by a mobile device.

32. The computer-readable storage medium of claim 24, wherein the computer-executable code for obtaining the motion data comprises computer-executable code for receiving the motion data at a server.

33. The computer-readable storage medium of claim 24, further comprising computer-executable code for sending the probability that that a step was made to a mobile device.

34. The computer-readable storage medium of claim 24, further comprising computer-executable code for estimating a timestamp indicative of a point in time, during the first time interval, that corresponds to the probability that a step was made.

35. An apparatus comprising:
means for obtaining motion data indicative of a user's movement during a first time interval;
means for determining one or more features of the motion data; and
means for calculating a probability that a step was made, wherein the probability is based on:
at least one feature of the one or more features, and
information indicative of the user's movement at a time prior to the first time interval.

36. The apparatus of claim 35, further comprising means for determining a motion state indicative of a type of the user's movement, wherein the means for calculating the probability that a step was made further include means for basing the calculation on the motion state.

37. The apparatus of claim 35, wherein:
the means for calculating the probability include means for basing the calculation on the information indicative of the user's movement at a time prior to the first time interval comprising a data model indicative of the user's movement at a second time interval previous to the first time interval, and
the apparatus further comprises means for updating the data model based on the motion data.

38. The apparatus of claim 35, further comprising:
means for using a data model to determine a pattern of the one or more features;
wherein the means for calculating the probability that a step was made further include means for basing the calculation on the pattern.

39. The apparatus of claim 38, wherein means for using the data model comprise means for using a hidden Markov model.

40. The apparatus of claim 35, wherein the means for calculating the probability further include means for using the one or more features indicative of at least one of:
a rate of change in acceleration,
a magnitude of a change in acceleration, or
a rate at which peaks in acceleration are detected.

41. The apparatus of claim 35, further comprising:
means for accessing a probability that motion data over a previous interval corresponds to a step;
wherein the means for calculating the probability that a step was made over the first time interval include means for least partially basing the calculation on the probability that motion data over a second time interval, previous to the first time interval, corresponds to a step.

42. The apparatus of claim 35, further comprising means for providing the probability that a step was made to an application executed by a mobile device.

43. The apparatus of claim 35, wherein the means for obtaining the motion data comprises means for receiving the motion data at a server.

44. The apparatus of claim 35, further comprising means for sending the probability that a step was made to a mobile device.

45. The apparatus of claim 35, further comprising means for estimating a timestamp indicative of a point in time, during the first time interval, that corresponds to the probability that a step was made.
